(19) United States
(12) Patent Application Publication
(10) Pub. No.: US 2024/0119295 A1
(43) Pub. Date: Apr. 11, 2024

(54) Generalized Bags for Learning from Label Proportions

(71) Applicant: Google LLC, Mountain View, CA (US)

(72) Inventors: Rishi Saket, Bangalore, Karnataka (IN); Aravindan Raghuveer, Bangalore, Karnataka (IN); Balaraman Ravindran, Chennai, Tamil Nadu (IN)

(21) Appl. No.: 18/013,053

(22) PCT Filed: Jan. 7, 2022
(86) PCT No.: PCT/US2022/011558

§ 371 Date: Dec. 27, 2022

(30) Foreign Application Priority Data
Nov. 2, 2021 (IN) 202121050228

(51) Int. Cl. G06N 3/09

(52) U.S. Cl. CPC G06N 3/09

(57) ABSTRACT

Example aspects of the present disclosure relate to an example method. The example method includes obtaining, by a computing system comprising one or more processors, a plurality of data bags. In the example method, each respective data bag of the plurality of data bags comprises a respective plurality of instances and is respectively associated with one or more proportion labels. The example method also includes generating, by the computing system, a plurality of training bags from the plurality of data bags according to a plurality of weights. In the example method, the training bags are generated such that a bag-level predicted proportion label error by a machine-learned prediction model over the plurality of training bags correlates to an instance-level predicted proportion label error by the machine-learned prediction model.

### RELATED APPLICATIONS

The present application is based on and claims priority to and the benefit of Indian Provisional Patent Application Number 202121050228, filed Nov. 2, 2021, which is hereby incorporated by reference herein in its entirety.

### FIELD

The present disclosure relates generally to training machine-learned models. More particularly, aspects of the present disclosure relate to training machine-learned models using label proportions.

### BACKGROUND

Generally, machine-learned models can be trained to infer information about an item using labeled instances of similar items. But in some weakly labeled datasets, instance-level labels may not be available. For example, in some weakly labeled datasets, a collection or “bag” of instances may only be labeled as containing a specified proportion of instances associated with a label. It may still be desired to train a machine-learned model to generate inferences at the instance level.

For example, in some real-world systems, data may only be collected without labels assigned to individual items. Individual items (or “instances”) may not be labeled (or may have incomplete labeling), but the collection (or “bag”) containing the instances may be tagged with proportion data indicating the relative proportions of labels represented within the bag. For example, a bag of unlabeled instances may contain proportion data indicating that one fraction has a first label (e.g., indicating that a fraction of instances are positive for a certain trait), and for datasets with multiple labels, respective proportions for each label may likewise be indicated.

As an example, data with labeled proportions can arise in implementations with limited data collection capacity. For example, data collection capacity can be limited by instrumentation precision or error, instrumentation capacity, experimental or observational constraints, feasibility or policy constraints, cost constraints (e.g., computational cost, data collection cost, etc.), and the like. Labeling capacity can also be limited, as in some cases individual label data for any one instance or set of instances may be absent, unknown, or even unknowable, while relative proportion data may be more readily obtained (e.g., using statistical or other models, probabilities known or estimated for the subject matter, batch estimates, coarse manual processing, etc.).

Various prior approaches to learning from label proportions have detrimentally relied on several limiting assumptions that have hindered real-world implementations. For example, some prior approaches have relied on class-conditioned independence assumptions—e.g., that examples within each bag are not correlated with each other via their features. Real-world behavior is often correlated, however: as one illustration, users of an automotive website who interact with content relating to one car may also tend to interact with content relating to competitor cars, so data relating to the interactions will likely be correlated. In another example, some prior approaches have relied on an assumed disjointedness property—e.g., that instances appear in exactly one bag and thus have equal representation. But in some real-world implementations, however, instances may not have equal representation: as one illustration, minority instance classes in a dataset may appear in few or only one bag (e.g., displaying long tail class membership distribution), while other more numerous instance classes may be present in multiple or many bags. And further, in some real-world implementations, a small subset of bags may inherently have a large number of instances while there is also a larger subset of small bags (e.g., displaying long tail bag size distribution). For example, as one illustration, flight telemetry for popular routes may correspond to larger bags than flight telemetry for less popular routes. With a diversity of bag sizes, the learning result from each bag can vary.

### SUMMARY

Aspects and advantages of embodiments of the present disclosure will be set forth in part in the following description, or can be learned from the description, or can be learned through practice of the embodiments.

In one example aspect, the present disclosure provides for an example method. The example method includes obtaining, by a computing system comprising one or more processors, a plurality of data bags. In the example method, each respective data bag of the plurality of data bags comprises a respective plurality of instances and is respectively associated with one or more proportion labels. The example method includes generating, by the computing system, a plurality of generalized training bags from the plurality of data bags according to a plurality of weights. In the example method, the generalized training bags are generated such that a bag-level predicted proportion label error by a machine-learned prediction model over the plurality of training bags correlates to an instance-level predicted proportion label error by the machine-learned prediction model.

In some embodiments, the example method includes obtaining, by the computing system, a plurality of unlabeled runtime instances. In some embodiments, the example method includes generating, by the computing system and using the machine-learned prediction model, output data descriptive of one or more of the unlabeled runtime instances and a label associated therewith. In some embodiments, the example method includes querying, by the computing system, the output data with a query label. In some embodiments, the example method includes returning, by the computing system, data descriptive of a subset of the output data associated with the query label. In some embodiments of the example method, the output data comprises a data store for instances identified as relevant to a query label. In some embodiments of the example method, the machine-learned prediction model is configured to retrieve one or more of the unlabeled runtime instances relevant to the query label.

In some embodiments, the example method includes inputting, by the computing system and into the machine-learned prediction model, input data based at least in part on the plurality of generalized training bags; obtaining, by the computing system, the bag-level prediction proportion label error; and updating, by the computing system, one or more parameters of the machine-learned prediction model based at least in part on the bag-level prediction proportion label error.

In some embodiments, the example method includes determining, by the computing system, a weight distribution for generating the plurality of generalized training bags from the plurality of data bags. In some embodiments, the example method further includes, for each respective generalized training bag of the plurality of generalized training bags: (i) sampling, by the computing system, a plurality of weights from the weight distribution; (ii) sampling, by the computing system, a plurality of data bags from a distribution of data bags; and (iii) outputting, by the computing system, the respective generalized training bag based at least in part on the plurality of weights and the plurality of data bags.

In one example aspect, the present disclosure provides for an example system. The example system includes one or more processors and one or more memory devices. The one or memory devices store computer-readable instructions that, when implemented, cause the one or more processors to perform operations. The operations include obtaining a plurality of data bags. In the example system, each respective data bag of the plurality of data bags comprises a respective plurality of instances and is respectively associated with one or more proportion labels. The operations include generating a plurality of generalized training bags from the plurality of data bags according to a plurality of weights. In the example system, the generalized training bags are generated such that a bag-level predicted proportion label error by a machine-learned prediction model over the plurality of training bags correlates to an instance-level predicted proportion label error by the machine-learned prediction model.

In one example aspect, the present disclosure provides for an example computer-readable medium storing computer-readable instructions for causing one or more processors to perform operations. The operations include obtaining a plurality of data bags. In the example system, each respective data bag of the plurality of data bags comprises a respective plurality of instances and is respectively associated with one or more proportion labels. The operations include generating a plurality of generalized training bags from the plurality of data bags according to a plurality of weights. In the example system, the generalized training bags are generated such that a bag-level predicted proportion label error by a machine-learned prediction model over the plurality of training bags correlates to an instance-level predicted proportion label error by the machine-learned prediction model.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an example system 100 for learning from generalized training bags according to example aspects of the present disclosure;

FIG. 2 depicts an example embodiment of a model trainer for learning from generalized training bags according to example aspects of the present disclosure;

FIG. 3 depicts an example processing system 300 for learning from generalized training bags according to example aspects of the present disclosure;

FIG. 4 depicts a flowchart of an example method for learning from generalized training bags according to example aspects of the present disclosure; and

FIG. 5 depicts a flowchart of another example method for learning from generalized training bags according to example aspects of the present disclosure.

Reference numerals that are repeated across plural figures are intended to identify the same features in various implementations.

### DETAILED DESCRIPTION

### Overview

Generally, the present disclosure is directed to techniques for training machine-learned models using input datasets having labeled proportions by transforming input datasets into a generalized intermediate representation before training. Example systems and methods according to example aspects of the present disclosure enable and support machine learning based on weakly-labeled real-world datasets by generating well-behaved training datasets from the real-world datasets.

Advantageously, embodiments according to example aspects of the present disclosure can transform a set of training bags (e.g., containing real-world data) to produce a set of generalized training bags that adhere to a set of desired criteria. For example, in some embodiments, the criteria can include characteristics of a desired training bag distribution to mitigate and/or eliminate the challenges posed by real-world data distributions. In this manner, for example, generalized training bags can be obtained to better train a model to generate improved instance-level inferences (e.g., even in the absence of instance-level training data).

Example systems and methods according to example aspects of the present disclosure can provide a variety of technical effects and benefits. For example, in some embodiments, example systems and methods can enable the use of machine-learned models in data-limited contexts that would otherwise lack sufficient data for training effective machine-learned models. In some embodiments, example systems and methods can permit training data to be generated (e.g., labeled) with less time, effort, and/or expense (e.g., computational expense) by providing for learning from real-world datasets for which proportion data can be obtained (e.g., retrieved, generated, etc.). For example, by overcoming various dependencies on limiting assumptions over underlying input data, example systems and methods can expand the capability of machine-learned computing systems to operate and effectively function in the real world using real-world input datasets.

In some embodiments, example systems and methods according to example aspects of the present disclosure can provide for improved storage, management, retrieval, and cross-referencing of data structures in a memory (e.g., in a database). For instance, an example database may contain real-world data structures descriptive of various unlabeled instances. The example database (or another database) may also contain bags of data structures descriptive of real-world instances, with the bags tagged with label proportions. Based on the tagged bags, an example computing system according to the present disclosure can generate an intermediate set of data structures for training a machine-learned model to associate a label with the unlabeled instances (e.g., to form one or more categories of the instance data structures, etc.). Although the intermediate set of data structures may not necessarily be interpretable to a human observer (e.g., interpretable as cognizably representing the underlying real-world data), the intermediate set of training data structures may be operable to cause the computing system executing the machine-learned model to learn to relate the unlabeled instance data structures with labels for storage. In this manner, for instance, the intermediate set of training data may function to provide for association of the unlabeled instance data structures in the database with one or more labels to enable improved storage and/or retrieval of those data structures (e.g., storage based on the one or more labels, retrieval based on the one or more labels, etc.).

In some embodiments, example systems and methods according to example aspects of the present disclosure can provide for indexing instances for a set of unlabeled instances (e.g., creating an index, generating labels for indexing, etc.). For instance, a set of unlabeled instances can be provided as an input to a machine-learned labeling model according to aspects of the present disclosure. The machine-learned labeling model can index the unlabeled instances according to one or more output labels, the model having been trained on an intermediate training data structure generated according to example aspects of the present disclosure. In this manner, for example, systems and methods according to example aspects of the present disclosure can provide for indexed data structures in contexts where, for example, indexing information (e.g., instance-level labels) may be unavailable, and thereby facilitate access to data.

In some embodiments, example systems and methods according to example aspects of the present disclosure can provide for determining a relevance of an unlabeled instance to one or more query values. For example, by associating unlabeled instances with one or more predicted instance labels using the generalized training bags according to the present disclosure, example systems and methods of the present disclosure may provide for retrieving those unlabeled instances by processing a query against the predicted instance label. In this manner, for example, systems and methods of the present disclosure may enable machine-learned models to determine a relevance of unlabeled data to a query using real-world data to train the models, and may thereby facilitate the execution of structured queries, for example.

As illustrated herein, example systems and methods of the present disclosure provide improvements to data storage, indexing, query processing, and results retrieval, which may in turn expand the resolution of computing system measurements (e.g., by predicting instance-level information based on bag-level observations), improve the ability of a computing system to relate data structures (e.g., by indexing previously unlabeled real-world data for querying), increase computational efficiency (e.g., by returning fewer null query results due to unlabeled data), and decrease computational cost (e.g., by predicting labels for unlabeled data instead of requiring manual regression and/or additional data gathering), in some examples. For example, in some embodiments, example systems and methods of the present disclosure can provide for a decreased data requirement for training model(s) to generate the instance labels. For example, by using an intermediate training data structure configured according to example aspects of the present disclosure, a number of samples used to obtain labeling of a desired accuracy can be bounded to a high confidence. In this manner, for instance, excess computational cost can be avoided (e.g., by transmitting, storing, and processing excess training data, etc.).

### Example Systems and Methods

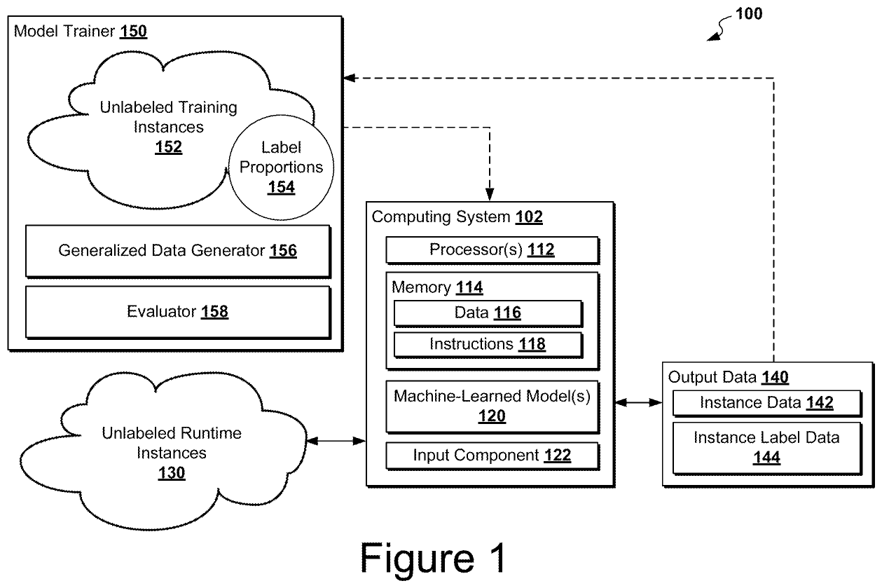

With reference now to the Figures, example embodiments of the present disclosure will be discussed in further detail. FIG. 1 depicts one example system 100 for generating inferences according to example aspects of the present disclosure. The example system 100 contains a computing system 102. The computing system 102 can be any type of system of one or more computing devices. A computing device can be, for example, a personal computing device (e.g., laptop or desktop), a mobile computing device (e.g., smartphone or tablet), a gaming console or controller, a wearable computing device, an embedded computing device, a server computing device, a node of a distributed computing device, a virtual instance hosted on a shared server, or any other type of computing device. In some embodiments, the computing system 102 includes a plurality of computing devices interconnected via a network or otherwise distributed in an interoperable manner. For example, the computing system 102 can include a server for serving content over a network (e.g., network 180). For instance, the computing system 102 can include a web server for hosting web content, for collecting data regarding web content (e.g., for receiving, monitoring, generating, or otherwise processing data regarding web content, such as the use, download of, and/or interaction with web content).

The computing system 102 can contain processor(s) 112 and memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the computing system 102 to perform operations.

In some implementations, the client computing system 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). In general, example system 100 can be model agnostic, such that various implementations of example system 100 may include or otherwise execute various machine-learned models that may not be adapted or specially tuned for, e.g., learning from label proportions.

The computing system 102 can also include one or more input components 122 that receives input (e.g., user input, input from other systems, etc.). For example, the input component 122 can be a touch-sensitive component (e.g., a touch-sensitive display screen or a touch pad) that is sensitive to the touch of an input object (e.g., a finger or a stylus). Other example input components include a microphone, a keyboard (e.g., physical and/or graphical), a network port (e.g., wireless, wired, etc.), a communication bus, and the like.

Embodiments of the example system 100 may be configured, as shown in FIG. 1, to receive unlabeled runtime instances 130 and produce output data 140. Unlabeled runtime instances 130 can include substantially any kind or type of data that may be descriptive of various phenomena. In general, an instance refers to a set of one or more data values grouped together to describe a particular subject or subject matter. For example, an instance can be a feature vector. An instance can be associated with image data (e.g., a feature vector for an image, a hashed image, etc.). An instance can be associated with a measurement or other data collection event (e.g., at a particular time, or of a particular subject, or using a particular device, or from a particular perspective, etc.). An instance can be associated with a network session, such as a set of interactions with a web server. In some embodiments, an instance can be associated with a user's interaction with web content (e.g., anonymous or identified).

In some embodiments, the unlabeled runtime instances 130 can contain no labels for the instances. In some embodiments, the unlabeled runtimes instances 130 can contain some label information but lack other label information. For example, the unlabeled runtime instances 130 may lack a label relevant to a label query desired to be processed on the set of unlabeled runtimes instances 130.

In some embodiments, output data 140 may include instance data 142 and instance label data 144. In some embodiments, the output data 140 contains a data structure relating one or more instances with labels (e.g., relating the instance data 142 to instance label data 144). For example, in some embodiments, output data 140 contains data effectively indexing the unlabeled runtime instances 130 according to one or more predicted labels.

For instance, in some embodiments, the output data 140 may be queried to retrieve one or more instances (e.g., data descriptive thereof, a count thereof, etc.) responsive or otherwise related to a label query. In some embodiments, output data 140 may be queried after generation by the machine-learned model(s) 120, and in some embodiments, output data 140 may be constructed as a data store for output(s) of the machine-learned model(s) 120 responsive to a particular query. For example, in some embodiments, output data 140 is determined as a data store for instances identified as relevant to a Query X, and the machine-learned model(s) 120 may be configured to retrieve one or more instances (e.g., data descriptive thereof, a count thereof, etc.) relevant to Query X from the unlabeled runtime instances 130 for output in the output data 140.

In some embodiments, the output data 140 can include one or more data structures for associating the unlabeled runtime instances 130 with one or more labels using the machine-learned model(s) 120. For example, the machine-learned model(s) 120 can index the unlabeled runtime instances 130 according to one or more labels predicted for each of the unlabeled runtime instances 130. In this manner, for example, the resulting output data 140 (e.g., one or more data structures therein) can be processed by execution of structured queries (e.g., filtering, sorting, categorizing, ranking, counting, etc.) based on the predicted labels.

A model trainer 150 may be configured to train the machine-learned model(s) 120 (e.g., to enable the labeling and/or query of unlabeled runtime instances 130). The model trainer 150 can contain unlabeled training instances 152 which have been tagged with label proportions 154. The unlabeled training instances 152 can include substantially any kind or type of data that may be descriptive of various phenomena, as discussed above with respect to unlabeled runtime instances 130. The label proportions 154 can be, in some examples, associated with one or more subsets of the unlabeled training instances 152. For example, the unlabeled training instances 152 may contain a plurality of data bags that each collect a number of instances of a dataset (e.g., a dataset of instances, such as a dataset of feature vectors, etc.). Each of the data bags can be associated with label proportions from label proportions 154. For example, label proportions 154 can contain a plurality of histograms indicating label frequency (e.g., for one or more labels), and each data bag of a plurality of data bags can be associated with a histogram for label frequency in that bag. In some embodiments, the label proportions 154 can include a set of one-hot label encodings.

The model trainer 150 can also include a generalized data generator 156. The generalized data generator 156 may be configured to transform the training data (e.g., the unlabeled training instances 152 and the label proportions 154) into an intermediate, generalized representation, and the model trainer 150 may train the machine-learned model(s) 120 using the intermediate, generalized representation. For example, in some embodiments, the machine-learned model(s) 120 may not be trained directly using the unlabeled training instances 152. In some embodiments, data bags collected from the unlabeled training instances 152 (along with associated label proportions 154) may be transformed into generalized training bags (along with associated generalized training label proportions, such as generalized histograms, etc.), and the machine-learned model(s) 120 may be trained using the training bags.

During training, in some embodiments, the training bags (e.g., the entire bag, instances from the bag, etc.) are passed to the machine-learned model(s) 120 for training (e.g., as illustrated with dashed lines for the training cycle). The output data 140 may then be a training output that can be passed back to the model trainer 150 for evaluation by the evaluator 158 (e.g., as illustrated with dashed lines for the training cycle). The evaluator 158 may determine whether the output data 140 aligns with the training data (e.g., the training bags) in a desired fashion. For example, the evaluator 158 may determine a value for an objective function over the output data 140. The evaluator 158 may determine a score, such as a loss, based on the output data 140 and the generalized training bags.

In some embodiments, the evaluator 158 is configured to determine an evaluation for the machine-learned model(s) 120 instance-level prediction output that correlates to one or more qualities of the training data. For example, the training data may include training bags associated with a label histogram. In some embodiments, the output data 140 may be aggregated into bags (e.g., to reconstruct the training bags and/or the histograms associated therewith) to evaluate the output data 140. In some embodiments, the evaluation of the output data 140 against the training bags correlates to a quality of the instance-level output. For example, the evaluator 158 may be configured to determine an objective for decreasing a bag-level error such that the objective may correlate to decreasing an instance-level error. In some embodiments, this correlation is enabled by the transformation of the unlabeled training instances 152 and the label proportions 154 into the training bags by the generalized data generator 156.

The model trainer 150 may update or cause to be updated (e.g., directly, indirectly) one or more parameters of the machine-learned model(s) 120 based at least in part on an output of the evaluator 158.

In some embodiments, the model trainer 150 is contained within the computing system 102. In some embodiments, the model trainer 150 is external to the computing system 102 (e.g., and connected thereto, such as via a network or other intersystem communication protocol)

In this manner, for example, training machine-learned model(s) 120 using generalized training bags configured according to example aspects of the present disclosure can provide for processing of queries against unlabeled runtime instances 130. For example, although the intermediate set of bags (the generalized training bags) may not necessarily be interpretable to a human observer (e.g., interpretable as cognizably representing the underlying real-world data), the intermediate set of training data structures can provide for learning a set of parameters for the machine-learned model(s) 120 to learn to relate the unlabeled runtime instances 130 with labels for structured storage. In this manner, for instance, the intermediate set of training data may function to enable improved storage, retrieval, and analytics of those unlabeled runtime instances 130 (e.g., storage based on the one or more labels, retrieval based on the one or more labels, etc.). For instance, training with the generalized bags of the present disclosure can provide for indexing of unlabeled runtime instances 130 using real-world training data (e.g., providing for actual implementation of the present techniques on computing systems, expanding their capability to perform queries where otherwise they might be uncapable of doing so).

For instance, example embodiments of generalized training bags according to the present disclosure advantageously can eliminate the challenges posed by the realities of intra-bag correlations (e.g., where prior techniques failed). Example embodiments of generalized training bags according to the present disclosure advantageously can eliminate the challenges posed by the realities of long-tail bag representation (e.g., where minority instance classes in a dataset may appear in few or only one bag). And example embodiments of generalized training bags according to the present disclosure advantageously can eliminate the challenges posed by the realities of long tail bag size distribution.

Of further advantage, for example, by overcoming many of the challenges faced by prior techniques for learning from label proportions, example embodiments of machine-learned model(s) including parameters determined using generalized training bags according to the present disclosure can provide for label predictions and data indexing using weakly-labeled training data, without the need for additional time and other resources to be expended to improve the labeling of the training data (e.g., manually, etc.).

For example, in some embodiments, the weakly-labeled training data can itself be generated according to one or more predictions. For instance, the label proportions can be predicted based on statistical or other knowledge about a population. In some embodiments, for example, population statistics may be known to some level of confidence higher than statistics for any one individual. In such an example, for instance, the knowledge of population level statistics can be leveraged to obtain instance-level label predictions according to example embodiments of the present disclosure. In this manner, for example, example embodiments of generalized training bags according to the present disclosure advantageously can decrease the amount of training data (or effort expended to obtain training data) that may be otherwise required to obtain indexed and/or labeled data structures.

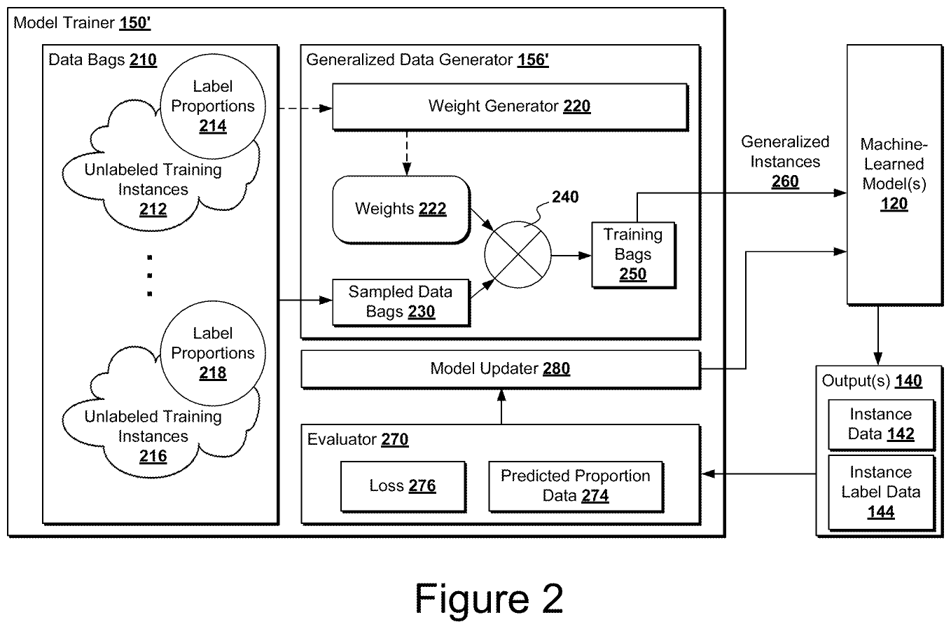

FIG. 2 depicts an example model trainer 150′. The example model trainer 150′ contains a plurality of data bags 210, each of which contains a number of unlabeled training instances and corresponding label proportions. For example, in one bag, unlabeled training instances 212 may correspond to label proportions 214, and in another bag, unlabeled training instances 216 may correspond to label proportions 218, and so on. In another example, unlabeled training instances 212 may be associated with a plurality of data bags, or a distribution of data bags, and may correspond to a distribution of label proportions 214 associated with the distribution of data bags. Likewise, in some embodiments, unlabeled training instances 216 may be associated with a plurality of data bags, or a distribution of data bags, and may correspond to a distribution of label proportions 218 associated with the distribution of data bags. Accordingly, in some embodiments, data bags 210 can include one or more (e.g., a plurality) of data bag distributions.

The data bags 210 can be accessed by the generalized data generator 156′. For example, a weight generator 220 can access the data bags 210 to generate a set of weights 222 (e.g., a plurality of weights 222). In some embodiments, the weight generator 220 can generate a weight distribution from which the weights 222 are sampled. A plurality of sampled data bags 230 may be sampled from the data bags 210 (e.g., sampled from one or more data bag distributions, etc.). In some embodiments, the weights 222 and the sampled data bags 230 may be independently sampled.

The weights 222 and the sampled data bags 230 can be input into a transformer 240 to generate the training bags 250. The transformer 240 can, for example, generate the training bags 250 from the sampled data bags 230 according to the weights 222. In some embodiments, the weights 222 are parameters of the transformer 240 (e.g., parameters of a model, such as a machine-learned model). In some embodiments, the sampled data bags 230 can be combined in a weighted combination according to the weights 222 (e.g., a linear combination). For example, in some embodiments, given a set of k data bags B and corresponding histograms σ, a generalized training bag can be expressed as B̅=Σ^{k}ᵢ₌₁wᵢBᵢ with corresponding generalized histogram σ̅=Σ^{k}ᵢ₌₁wᵢσᵢ, where wᵢ indicates the i-th weight of a set of k weights (e.g., of the set of weights 222).

The training bags 250 can be used by the model trainer 150′ to provide instances as inputs to the machine-learned model(s) 120 (e.g., generalized training instances 260) to obtain output(s) 140. The model trainer 150′ can access the output(s) 140 for evaluation. For example, evaluator 270 can access the output(s) 140 to determine predicted proportion data 274 (e.g., by determining proportions of a collection of predicted instances from the instance data 142 and the instance label data 144, such as by effectively reconstructing the generalized histogram(s) associated with the generalized training bags 250). Using the predicted proportion data 274, the evaluator 270 can determine a loss 276. For example, the loss 276 can include a distance error. For example, the loss 276 can include a Euclidean loss, such as an L1 loss, an L2 loss, etc., such as a squared Euclidean loss summed over the outputs (e.g., summed over the predicted proportion data 274 for each of the training bags 250). In some embodiments, however, the evaluator 270 can determine a loss 276 directly from the output(s) 140 (e.g., without first determining predicted proportion data 274).

Based at least in part on an output or result of the evaluator 270, a model updater 280 may update the machine-learned model(s) 120 (e.g., one or more parameters thereof). For example, the model updater 280 can include or execute substantially any model update technique, such as gradient-based methods, evolutionary methods, etc.

In some embodiments, the weight generator 220 may be run asynchronously with the generation of the training bags 250. For example, in one embodiment, the weight generator 220 can run initially to determine a set of weights 222. The set of weights 222 may then be used to generate a plurality of training bags 250 using the data bags 210. In some embodiments, the same set of weights 222 may be used for data bags other than and/or additional to the data bags 210. In some embodiments, the weight generator 220 can be executed responsive to a trigger from the evaluator 270: for example, the weight generator 220 can be triggered by an output error above a threshold.

In some embodiments, the weight generator 220 can determine a weight distribution to obtain training bags 250 configured to induce a correlation between a bag-level loss on the output(s) 140 and an instance-level error on the output(s) 140. In some embodiments, for example, the weight generator 220 can determine a weight distribution such that the training bags 250 are associated with an isotropic training bag distribution (e.g., generative of a plurality of isotropic training bags 250).

In some examples, a training bag 250 distribution can be considered isotropic if characteristic vectors of the training bags are sampled from an isotropic distribution. For example, a characteristic vector can be determined for one or more data bags 210 (e.g., optionally uniquely identifying each bag). As the data bags 210 are transformed via the generalized data generator 156′, so too the bags' characteristic vectors may be transformed accordingly, resulting in a characteristic vector for each of the training bags 250. For example, in some embodiments, given a data bag Bᵢ⊆[n], a characteristic vector for the data bag can be expressed as [symbol] _{B}_{ᵢ}∈{0, 1}ⁿ. Accordingly, in some embodiments, a characteristic vector for a corresponding generalized training bag B̅=Σ^{k}ᵢ₌₁ wᵢBᵢ can be expressed as α_{B̅}=Σ^{k}ᵢ₌₁wᵢBᵢ.

In this manner, for example, an isotropy condition can be evaluated with respect to characteristic vectors of the training bags 250. In some examples, the weights 222 may be sampled from a weight distribution generated by the weight generator 220 such that one or more characteristic vectors generated using the weights 222 may be effectively sampled from an isotropic distribution.

In some examples, determining a weight distribution such that one or more characteristic vectors generated using the weights 222 may be effectively sampled from an isotropic distribution includes solving (e.g., exactly, approximately, analytically, numerically, etc.) a convex problem, such as with a semidefinite program solution. In some embodiments, determining a weight distribution such that one or more characteristic vectors generated using the weights 222 may be effectively sampled from an isotropic distribution includes solving for a covariance matrix of the weight distribution to satisfy an isotropy constraint. In some embodiments, the isotropy constraint can be relaxed (e.g., by inserting a relaxation value).

In some embodiments, a covariance matrix may be determined such that its trace is reduced (e.g., minimized). For example, the trace of the covariance matrix may be related to a bound on the sample size used to obtain a desired error bound (e.g., results within a given error amount). For example, a sample size used to obtain a desired error bound with a probability (e.g., a high probability) can be decreased by decreasing the bound of the norm of the characteristic vector(s) of the training bags 250. In some embodiments, decreasing the trace of the covariance matrix corresponds to decreasing the bound of the norm of the characteristic vector(s) of the training bags 250.

In some embodiments, the covariance matrix may be used to obtain a weight distribution. For example, in some embodiments, the covariance matrix is a positive semidefinite covariance matrix which can be decomposed and the decomposition uniformly sampled as weights 222 to give the weight distribution. In some embodiments, a set of weights 222 can be taken as a mean-zero Gaussian vector sampled using the covariance matrix.

In some embodiments, a solution for the covariance matrix (e.g., a solution to the convex problem, such as the semidefinite program) may not be feasible. For example, an approximate solution may be used instead. In some embodiments, the weight generator 220 can determine a feasibility and, responsive to determining the feasibility, obtain an approximate solution (e.g., by relaxing an isotropy constraint). In some embodiments, the weight generator 220 may return an error, and/or may default to previously obtained weights 222.

For example, in some embodiments, Algorithm 1 may be used to obtain a weight distribution.
Algorithm 1: Find-Weight-Distribution
   Input data bags/distributions;
   Attempt solution for covariance matrix;
   If solution infeasible then provide approximation end if;
   Return weight distribution sampled using W;

With one or more weight distributions, Algorithm 2 may be used to obtain a training bag of the training bags 250.
Algorithm 2: Generate-Training-Bag
   Input independent distribution(s) of weights and data bags;
   Sample, independently, data bags from data bag distribution(s);
   Sample, independently, weights from weight distribution(s);
   Return generalized bag obtained using sampled data bags and sampled weights;

For example, in one embodiment, given multiple bag distributions {D₁, . . . , Dₖ} a weight vector w=w₁, . . . , wₖ may be obtained from a weight distribution to provide a generalized bag B̅=Σ^{k}ᵢ₌₁wᵢBᵢ with generalized histogram σ̅=Σ^{k}ᵢ₌₁wᵢσᵢ, where Bᵢ∀i ∈[k] are independent, respective samples of Dᵢ∀i ∈[k] and σ is the histogram associated with Bᵢ, and with Bᵢ⊆[n] and second moment matrix A⁽ⁱ⁾= [symbol] [ [symbol] _{B}_{ᵢ} [symbol] ^{T}_{B}_{ᵢ}], where the (u, v)-th coordinate of A⁽ⁱ⁾ is denoted A⁽ⁱ⁾_{u, v}. The obtained generalized bag B̅ may be expressed as [symbol] having a characteristic vector Z=Σ^{k}ᵢ₌₁w [symbol] _{B}_{ᵢ}∈ [symbol] ⁿ. Using this example terminology, for instance, a covariance matrix W may be obtained by solving (e.g., exactly, approximately, etc.) Equation 1, optionally while also including the minimization objective of the trace of W,

$$∀ u , v ∈ [ n ] , {\sum }_{i = 1}^{k} {W}_{i , i} {A}_{u , v}^{( i )} + {\sum }_{\begin{matrix}1 \leq i , j \leq k \\ i \neq j\end{matrix}} {W}_{i , j} {A}_{u , u}^{( i )} {A}_{v , v}^{( j )} = {\{ u = v \}}_{} \qquad ( 1 )$$

An approximate solution may be obtained for y_{u, v}≥0 (e.g., one for each tuple (u, v) ∈[n]×[n]) satisfying Equation 2 while optionally including the minimization objective trace(W)+λΣ_{u, v}y_{u, v} for appropriate λ≥0.

$$∀ u , v ∈ [ n ] , \vert {\sum }_{i = 1}^{k} {W}_{i , i} {A}_{u , v}^{( i )} + {\sum }_{\begin{matrix}1 \leq i , j \leq k \\ i \neq j\end{matrix}} {W}_{i , j} {A}_{u , u}^{( i )} {A}_{v , v}^{( j )} - {\{ u = v \}}_{} \vert \leq {y}_{u , v} \qquad ( 2 )$$

In some embodiments, one or more relaxation values (e.g., y_{u, v}) may be introduced. For example, in some embodiments, the number of relaxation variables can be quadratic in the number of instances in a training dataset. In some embodiments, independence in the sampling of instances in the bags of one or more bag distributions can provide for solving the relaxed problem on groups of instances (e.g., clusters of two instances each).

In some embodiments, the above algorithms can be restated as follows:
Algorithm 1′: Find-Weight-Distribution
   Input {A⁽ⁱ⁾) i ∈[k]};
   Attempt solution for Equation 1;
   If solution infeasible then provide solution to Equation 2 end if;
   Return weight distribution sampled using W;
For instance, the weight distribution G_{w} can be returned by decomposing W=Σ^{k}ᵢ₌₁a^{(r)}(a^{(r)})^{T} and returning G_{w} by sampling √ka^{(r)} for r∈[k] uniformly as w. The weight distribution G_{w} can also be returned by taking w as a mean-zero Gaussian vector sampled using W as N(0, W).
Algorithm 2′: Generate-Training-Bag
   Input independent distribution(s) G_{w} and {D₁, . . . , Dₖ};
   Sample, independently, data bags from data bag distribution(s) as

(Bᵢ,σᵢ)←Dᵢ(1≤i≤k);
Sample, independently, weights from weight distribution(s) as

W→G_{w};
Return generalized bag with corresponding generalized histogram as

(B̅ᵢ,Σ̅ᵢ)→Dᵢ(1≤i≤k);
In some embodiments, the model trainer 150′ via the generalized data generator 156′ may construct a plurality of training bags 250 (e.g., with their corresponding generalized label proportions) by executing, for example, Algorithm 2 or 2′ to generate each of the plurality of training bags 250.

In some embodiments, the number of training bags 250 used to obtain a target accuracy and/or error rate may be bounded by a value related to a norm of one or more characteristic vectors (e.g., the maximum norm of the characteristic vectors). In some embodiments, the maximum norm of the characteristic vectors may be expressed as k\sqrt{n tr(W)}, such that the number of training bags 250 used to obtain a target accuracy and/or error rate may be bounded by a value expressed as O(opt·(k²n log n)/δ²) to obtain, with probability of at least 1−n⁻³, (σₘᵢₙ(A), σₘₐₓ(A)) ∈[1−δ, 1+δ], where opt is the value of the semidefinite program solved in Algorithm 1′.

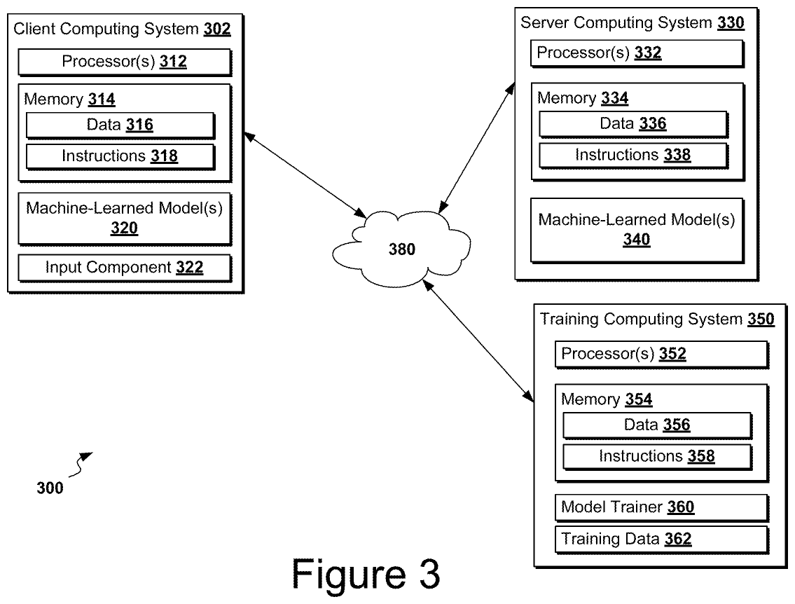

FIG. 3 depicts a block diagram of an example computing system 300 according to example embodiments of the present disclosure. The example system 300 includes a client computing system 302, a server computing system 330, and a training computing system 350 that are communicatively coupled over a network 380.

The client computing system 302 can be any type of system of one or more computing devices. A computing device can be, for example, a personal computing device (e.g., laptop or desktop), a mobile computing device (e.g., smartphone or tablet), a gaming console or controller, a wearable computing device, an embedded computing device, a server computing device, a node of a distributed computing device, a virtual instance hosted on a shared server, or any other type of computing device. In some embodiments, the client computing system 302 includes a plurality of computing devices interconnected via a network or otherwise distributed in an interoperable manner. For example, the client computing system 302 can include a server for serving content over a network (e.g., network 380). For instance, the client computing system 302 can include a web server for hosting web content, for collecting data regarding web content (e.g., for receiving, monitoring, generating, or otherwise processing data regarding web content, such as the use, download of, and/or interaction with web content).

The client computing system 302 includes one or more processors 312 and a memory 314. The one or more processors 312 can be any suitable processing device (e.g., a processor core, a microprocessor, an ASIC, an FPGA, a controller, a microcontroller, etc.) and can be one processor or a plurality of processors that are operatively connected. The memory 314 can include one or more non-transitory computer-readable storage media, such as RAM, ROM, EEPROM, EPROM, flash memory devices, magnetic disks, etc., and combinations thereof. The memory 314 can store data 316 and instructions 318 which are executed by the processor 312 to cause the client computing system 302 to perform operations.

In some implementations, the client computing system 302 can store or include one or more machine-learned models 320. For example, the machine-learned model(s) 320 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned model(s) 320 are discussed with reference to machine-learned model(s) 120.

In some implementations, the one or more machine-learned models 320 can be received from the server computing system 330 over network 380, stored in the client computing system memory 314, and then used or otherwise implemented by the one or more processors 312. In some implementations, the client computing system 302 can implement multiple parallel instances of a single machine-learned model 320.

Additionally or alternatively, one or more machine-learned models 340 can be included in or otherwise stored and implemented by the server computing system 330 that communicates with the client computing system 302 according to a client-server relationship. For example, the machine-learned models 340 can be implemented by the server computing system 340 as a portion of a web service (e.g., a service for processing unlabeled runtime instances according to any of the various aspects of the present disclosure). Thus, one or more machine-learned models 320 can be stored and implemented at the client computing system 302 and/or one or more machine-learned models 340 can be stored and implemented at the server computing system 330.

The client computing system 302 can also include one or more input components 322 that receives input (e.g., user input, input from other systems, etc.). For example, the input component 322 can be a touch-sensitive component (e.g., a touch-sensitive display screen or a touch pad) that is sensitive to the touch of an input object (e.g., a finger or a stylus). Other example input components include a microphone, a keyboard (e.g., physical and/or graphical), a network port (e.g., wireless, wired, etc.), a communication bus, and the like.

The server computing system 330 includes one or more processors 332 and a memory 334. The one or more processors 332 can be any suitable processing device (e.g., a processor core, a microprocessor, an ASIC, an FPGA, a controller, a microcontroller, etc.) and can be one processor or a plurality of processors that are operatively connected. The memory 334 can include one or more non-transitory computer-readable storage media, such as RAM, ROM, EEPROM, EPROM, flash memory devices, magnetic disks, etc., and combinations thereof. The memory 334 can store data 336 and instructions 338 which are executed by the processor 332 to cause the server computing system 330 to perform operations.

In some implementations, the server computing system 330 includes or is otherwise implemented by one or more server computing devices. In instances in which the server computing system 330 includes plural server computing devices, such server computing devices can operate according to sequential computing architectures, parallel computing architectures, or some combination thereof.

As described above, the server computing system 330 can store or otherwise include one or more machine-learned models 340. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

In some embodiments, client computing system 302 has access to information unavailable to the server computing system 330 and/or the training computing system 350. In some embodiments, the client computing system 302 can be configured to host first-party content. First-party content can include, for example, content associated with the owner, operator, and/or beneficiary of the client computing system 302 (e.g., contractual beneficiary, such as a lessee of computing time on the client computing system 302). In some embodiments, the client computing system 302 may collect data (e.g., telemetry, analytics, usage statistics, logs, etc.) regarding the download, viewing, and use of first-party content.

The server computing system 330 may not have full or unrestricted access to first-party content on the client computing system 302 or unrestricted access to data regarding the viewing and use of the content. However, in some examples, the server computing system 330 may have access to data descriptive of third-party content related to the first party content (e.g., content linking to or otherwise promoting the first-party content). Due to technical, legal, or regulatory limitations, the client computing system may only be able to provide in some cases weakly labeled data descriptive of the first-party content and interactions therewith. Accordingly, one or more machine-learned models 340 may advantageously be trained according to example aspects of the present disclosure to associate the data descriptive of the third-party content with various instances in data descriptive of the first party content.

In one example, for instance, a client computing system 302 may host first-party web content. A server computing system 330 may host third-party advertising content. Interactions with the third-party advertising content may be correlated to interactions with the first-party web content. It may be desired to associate the interactions with the third-party content with subsequent interactions with the first-party content. For example, the first-party content provider may be interested in determining which interactions with the third-party content led to which interactions with the first-party content. For example, it may be desired to index the interactions with the third-party content according to labels associated with the first party content (e.g., conversions, other metrics, etc.).

Information to link the interactions may be limited. For example, information on the first-party interactions may be owned by the first-party provider, and there may be restrictions on the first-party provider's ability to grant complete access to that information. Information on the third-party interactions may likewise be restricted in various ways such that the first-party provider is unable to have complete access or visibility into the third-party interactions. However, the first-party provider may, in some embodiments, have access to some information regarding the third-party interaction (e.g., a query text processed on the third-party platform, a creative ID or campaign ID for the third-party content, etc.). In some embodiments, the first-party provider may upload or otherwise transmit data descriptive of the first-party interactions, along with whatever third-party interaction information may be associated therewith, to the server computing system 330 for processing. In some embodiments, the first-party provider may only upload only weakly-labeled data (e.g., labeled only with label proportions, such as a percentage of conversions, etc.).

Advantageously, one or more machine-learned models 340 may be trained according to example aspects of the present disclosure to learn to generate the relationships between the first-party data and the third-party data (e.g., to generate one or more indexed data structures) using the uploaded data and optionally any other data on third-party platform associated therewith. In this manner, for example, the server computing system 330 can (e.g., at runtime) process instances of third-party interactions to determine one or more labels associated therewith (e.g., conversion, attribution, etc.). For example, the server computing system 330 can process instances of third-party interactions for running one or more queries against the instances. Advantageously, the instances may be in some embodiments indexed (e.g., configured for effective querying) according to example aspects of the present disclosure. For example, the server computing system 330 can generate generalized training bags from the first-party data (e.g., first party data uploaded or otherwise transmitted to the server computing system 330, etc.) for training one or more machine-learned models 340 according to example aspects of the present disclosure to process the instances of third-party interactions for running one or more queries against the instances.

The client computing system 302 and/or the server computing system 330 can train the models 320 and/or 340 via interaction with the training computing system 350 that is communicatively coupled over the network 380. The training computing system 350 can be separate from the server computing system 330 or can be a portion of the server computing system 330.

The training computing system 350 includes one or more processors 352 and a memory 354. The one or more processors 352 can be any suitable processing device (e.g., a processor core, a microprocessor, an ASIC, an FPGA, a controller, a microcontroller, etc.) and can be one processor or a plurality of processors that are operatively connected. The memory 354 can include one or more non-transitory computer-readable storage media, such as RAM, ROM, EEPROM, EPROM, flash memory devices, magnetic disks, etc., and combinations thereof. The memory 354 can store data 356 and instructions 358 which are executed by the processor 352 to cause the training computing system 350 to perform operations. In some implementations, the training computing system 350 includes or is otherwise implemented by one or more server computing devices.

The training computing system 350 can include a model trainer 360 that trains the machine-learned models 320 and/or 340 stored at the client computing system 302 and/or the server computing system 330 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. In some implementations, performing backwards propagation of errors can include performing truncated backpropagation through time. The model trainer 360 can perform a number of techniques (e.g., weight decays, dropouts, etc.) to improve a capability of the models being trained.

In particular, the model trainer 360 can train the machine-learned models 320 and/or 340 based on a set of training data 362. The training data 362 can include, for example, generalized training data according to example aspects of the present disclosure (e.g., as discussed above, such as with reference to FIGS. 1 and 2). For example, in some embodiments, the model trainer 360 can be or comprise a model trainer 150 or 150′.

In some implementations, the training data 362 can include data provided by the client computing system 302. Thus, in such implementations, the model 320 provided to the client computing system 302 and/or the model 340 provided to the server computing system 330 can be trained by the training computing system 350 on data received from the client computing system 302. In some embodiments, the training data 362 includes data not otherwise accessible by the server computing system 330 and/or the training computing system 350 except as provided by the client computing system 302.

The model trainer 360 includes computer logic utilized to provide desired functionality. The model trainer 360 can be implemented in hardware, firmware, and/or software controlling a general purpose processor. For example, in some implementations, the model trainer 360 includes program files stored on a storage device, loaded into a memory and executed by one or more processors. In other implementations, the model trainer 360 includes one or more sets of computer-executable instructions that are stored in a tangible computer-readable storage medium such as RAM, hard disk, or optical or magnetic media.

The network 380 can be any type of communications network, such as a local area network (e.g., intranet), wide area network (e.g., Internet), or some combination thereof and can include any number of wired or wireless links. In general, communication over the network 380 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification (e.g., models 120, 320, 340, etc.) may be used in a variety of tasks, applications, and/or use cases. In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may include a text output which is mapped to the spoken utterance. In some cases, the task comprises encrypting or decrypting input data. In some cases, the task comprises a microprocessor performance task, such as branch prediction or memory address translation.

In some embodiments, any of the inputs described above may be provided for a labeling task or other indexing task. For example, any of the inputs described above, or other inputs, may be or comprise instances, such as unlabeled instances (e.g., lacking some or all labeling, such as lacking a desired labeling). In some embodiments, the task is to process a query against the input instances. The output (e.g., or an intermediate output) can include a data structure relating the unlabeled instances with one or more values indicating a relation to a query label. In this manner, for example, the task can be an indexing task, to index unlabeled instances for the processing of queries on label data (e.g., label data regarding labels not previously associated with the instances). The output can include a count or other summary output descriptive of the relationship(s) between the unlabeled instances and the query label(s). The output can include a retrieval of the unlabeled instance(s) determined as relevant to the query label(s). In some embodiments, the index may be transient (e.g., stored to obtain various metrics and/or analytics from processing queries against the indexed instances and later offloaded) or stored for a longer than transient duration (e.g., written to disk, etc.).

FIG. 3 illustrates one example computing system that can be used to implement the present disclosure. Other computing systems can be used as well. For example, in some implementations, the client computing system 102 can include the model trainer 160 and the training dataset 162. In such implementations, the models 120 can be both trained and used locally at the client computing system 102. In some of such implementations, the client computing system 102 can implement the model trainer 160 to personalize the models 120 based on user-specific data.

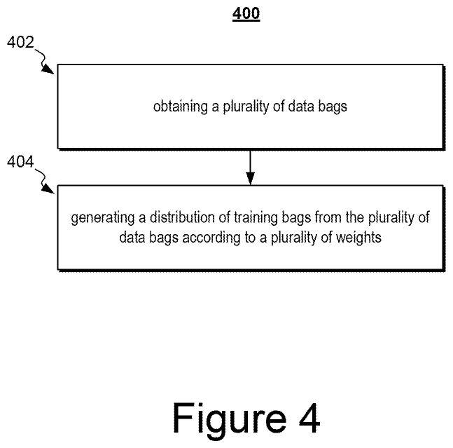

FIG. 4 depicts a flow chart diagram of an example method 400 to perform according to example embodiments of the present disclosure. Although FIG. 4 depicts steps performed in a particular order for purposes of illustration and discussion, the methods of the present disclosure are not limited to the particularly illustrated order or arrangement. The various steps of the example method 400 can be omitted, rearranged, combined, and/or adapted in various ways without deviating from the scope of the present disclosure.

At 402, example method 400 includes obtaining a plurality of data bags. In some embodiments, each respective data bag of the plurality of data bags corresponds to a respective plurality of instances and is respectively associated with one or more proportion labels. In some embodiments, the one or more data bags are samples from one or more data bag distributions. In some embodiments, the one or more data bags are obtained by a server computing system from a client computing system. In some embodiments, the one or more data bags contain data records from the server computing system and from the client computing system.

At 404, example method 400 includes generating a distribution of training bags from the plurality of data bags according to a plurality of weights. In some embodiments, the plurality of generalized training bags are generated such that a bag-level predicted proportion label error by a machine-learned prediction model over the plurality of training bags correlates to an instance-level predicted proportion label error by the machine-learned prediction model. In some embodiments of the example method 400, the bag-level predicted proportion label error is based at least in part on a distance error. In some embodiments of the example method 400, the bag-level predicted proportion label error is based at least in part on a Euclidean error. In some embodiments of the example method 400, the bag-level predicted proportion label error is based at least in part on a squared Euclidean error.

In some embodiments of the example method 400, generating the plurality of generalized training bags comprises generating a generalized training bag distribution. In some embodiments of the example method 400, the plurality of generalized training bags are samples from the generalized training bag distribution.

In some embodiments, the example method 400 further includes obtaining a plurality of unlabeled runtime instances. In some embodiments, the example method 400 further includes generating, using the machine-learned prediction model, output data descriptive of one or more of the unlabeled runtime instances and a label associated therewith.

In some embodiments, the example method 400 further includes determining a relevance between a label query and the instance label data. In some embodiments, the example method 400 further includes querying the output data with a query label and returning data descriptive of a subset of the output data associated with the query label. In some embodiments, the example method 400 further includes outputting instance label data predicted by the machine-learned prediction model for one or more of the plurality of instances. In some embodiments, the example method 400 further includes outputting a data structure comprising the instance label data and data descriptive of one or more of the plurality of instances associated with the instance label data.

In some embodiments, in the example method 400, the output data comprises a data store for instances identified as relevant to a query label and the machine-learned prediction model is configured to retrieve one or more of the unlabeled runtime instances relevant to the query label.

In some embodiments, the example method 400 further includes inputting, into the machine-learned prediction model, input data based at least in part on the plurality of generalized training bags. In some embodiments, the example method 400 further includes obtaining the bag-level prediction proportion label error. In some embodiments, the example method 400 further includes updating one or more parameters of the machine-learned prediction model based at least in part on the bag-level prediction proportion label error.

In some embodiments of the example method 400, the plurality of generalized training bags are based at least in part on a combination of one or more data bags according to the plurality of weights. In some embodiments of the example method 400, the plurality of generalized training bags are based at least in part on a linear combination of one or more data bags according to the plurality of weights.

In some embodiments of the example method 400, the weight distribution is determined at least in part based on a system of equations having coefficients derived from covariance matrices (and/or second moment matrices) of one or more data bag distributions. In some embodiments of the example method 400, the weight distribution is determined according to a relaxed constraint on the isotropy of the generalized training bag distribution. In some embodiments, the example method 400 further includes selecting the relaxed constraint responsive to determining an infeasibility of an ideal weight distribution. In some embodiments of the example method 400, the plurality of weights are based at least in part on a solution to a convex problem. In some embodiments of the example method 400, the plurality of weights are based at least in part on a solution to a semi-definite program.

In some embodiments of the example method 400, the plurality of weights are sampled from a weight distribution. In some embodiments of the example method 400, the plurality of weights are sampled from a weight distribution to obtain an isotropic distribution of characteristic vectors corresponding to the plurality of generalized training bags.

In some embodiments of the example method 400, the method is model agnostic. In some embodiments of the example method 400, the data bags comprise real-world data.

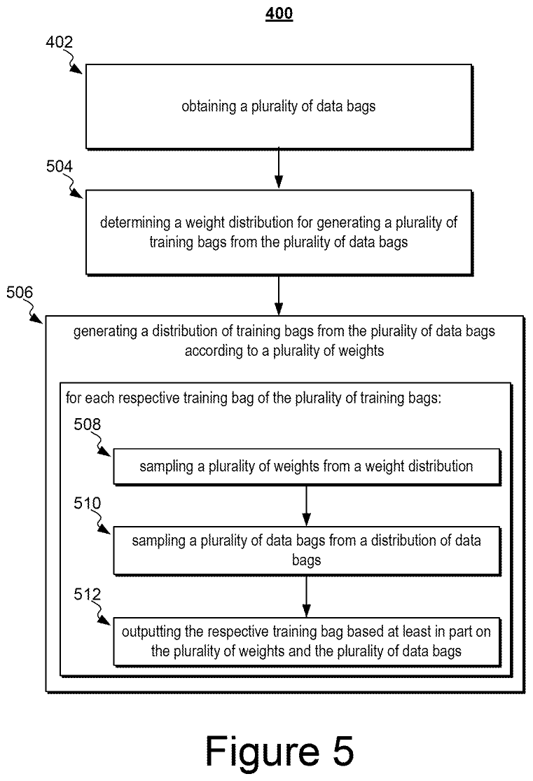

In some embodiments, the example method 400 further includes determining a weight distribution for generating the plurality of generalized training bags from the plurality of data bags. For example, FIG. 5 depicts a flow chart diagram of an embodiment of example method 400 to perform according to example embodiments of the present disclosure. Although FIG. 5 depicts steps performed in a particular order for purposes of illustration and discussion, the methods of the present disclosure are not limited to the particularly illustrated order or arrangement. At 504, for example, example method 400 includes determining a weight distribution for generating the plurality of generalized training bags from the plurality of data bags.

At 506, example method 400 further includes, for each respective generalized training bag of the plurality of generalized training bags: (at 508) sampling, by the computing system, a plurality of weights from the weight distribution; (at 510) sampling, by the computing system, a plurality of data bags from a distribution of data bags; and (at 512) outputting, by the computing system, the respective generalized training bag based at least in part on the plurality of weights and the plurality of data bags.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A method, comprising:
obtaining, by a computing system comprising one or more processors, a plurality of data bags, wherein each respective data bag of the plurality of data bags comprises a respective plurality of instances and is respectively associated with one or more proportion labels;
generating, by the computing system, a plurality of generalized training bags from the plurality of data bags according to a plurality of weights;
wherein the plurality of generalized training bags are generated such that a bag-level predicted proportion label error by a machine-learned prediction model over the plurality of training bags correlates to an instance-level predicted proportion label error by the machine-learned prediction model.

2. The method of claim 1, comprising:
inputting, by the computing system and into the machine-learned prediction model, input data based at least in part on the plurality of generalized training bags;
obtaining, by the computing system, the bag-level prediction proportion label error; and
updating, by the computing system, one or more parameters of the machine-learned prediction model based at least in part on the bag-level prediction proportion label error.

3. The method of claim 1, comprising:
determining, by the computing system, a weight distribution for generating the plurality of generalized training bags from the plurality of data bags; and
for each respective generalized training bag of the plurality of generalized training bags,
sampling, by the computing system, a plurality of weights from the weight distribution;
sampling, by the computing system, a plurality of data bags from a distribution of data bags; and
outputting, by the computing system, the respective generalized training bag based at least in part on the plurality of weights and the plurality of data bags.

4. The method of claim 1, comprising:
obtaining, by the computing system, a plurality of unlabeled runtime instances; and
generating, by the computing system and using the machine-learned prediction model, output data descriptive of one or more of the unlabeled runtime instances and a label associated therewith.

5. (canceled)

6. The method of claim 4, wherein:
the output data comprises a data store for instances identified as relevant to a query label; and
the machine-learned prediction model is configured to retrieve one or more of the unlabeled runtime instances relevant to the query label.

7. The method of claim 1, wherein the plurality of generalized training bags are based at least in part on a combination of one or more data bags according to the plurality of weights.

8. (canceled)

9. The method of any ene of claim 1, wherein the one or more data bags are samples from one or more data bag distributions.

10. (canceled)

11. The method of any claim 1, wherein the plurality of weights are based at least in part on a solution to a semi-definite program.

12. The method of any claim 1, wherein the plurality of weights are sampled from a weight distribution.

13. The method of claim 1, wherein the plurality of weights are sampled from a weight distribution to obtain an isotropic distribution of characteristic vectors corresponding to the plurality of generalized training bags.

14. (canceled)

15. (canceled)

16. The method of any claim 1, wherein the bag-level predicted proportion label error is based at least in part on a distance error.

17. (canceled)

18. The method of any claim 1, wherein the bag-level predicted proportion label error is based at least in part on a squared Euclidean error.

19. The method of any claim 12, wherein generating the plurality of generalized training bags comprises generating a generalized training bag distribution.

20. The method of any claim 1, wherein the plurality of generalized training bags are samples from the generalized training bag distribution.

21. The method of claim 19, wherein the weight distribution is determined according to a relaxed constraint on isotropy of the generalized training bag distribution.

22. The method of claim 21, comprising:
selecting the relaxed constraint responsive to determining an infeasibility of an ideal weight distribution.

23. The method of claim 12, wherein the weight distribution is determined at least in part based on a system of equations having coefficients derived from covariance matrices of one or more data bag distributions.

24. The method of claim 12, wherein the weight distribution is determined at least in part based on a system of equations having coefficients derived from second moment matrices of one or more data bag distributions.

25. (canceled)

26. (canceled)

27. (canceled)

28. A system, comprising:
one or more processors; and
one or more memory devices storing computer-readable instructions that, when implemented, cause the one or more processors to perform operations, the operations comprising:
obtaining a plurality of data bags, wherein each respective data bag of the plurality of data bags comprises a respective plurality of instances and is respectively associated with one or more proportion labels;
generating a plurality of generalized training bags from the plurality of data bags according to a plurality of weights; and
wherein the plurality of generalized training bags are generated such that a bag-level predicted proportion label error by a machine-learned prediction model over the plurality of training bags correlates to an instance-level predicted proportion label error by the machine-learned prediction model.

29. A computer-readable medium storing computer-readable instructions for causing one or more processors to perform operations, the operations comprising:
obtaining a plurality of data bags, wherein each respective data bag of the plurality of data bags comprises a respective plurality of instances and is respectively associated with one or more proportion labels;
generating a plurality of generalized training bags from the plurality of data bags according to a plurality of weights; and
wherein the plurality of generalized training bags are generated such that a bag-level predicted proportion label error by a machine-learned prediction model over the plurality of training bags correlates to an instance-level predicted proportion label error by the machine-learned prediction model.
